(19) United States
(12) Patent Application Publication
(10) Pub. No.: US 2004/0019594 A1
(43) Pub. Date: Jan. 29, 2004

(54) Customized electronic form assembly and ordering system and method

(76) Inventors: James H. Segapeli, Schertz, TX (US); Aurelio Prifitera, San Antonio, TX (US); Josiah J. Leverich, San Antonio, TX (US); Brian Collins, San Antonio, TX (US)

Correspondence Address: ALLEN, DYER, DOPPELT, MILBRATH & GILCHRIST, PA, P.O. BOX 3791, ORLANDO, FL, 32802-3791, US

(21) Appl. No.: 10/414,424

(22) Filed: Apr. 15, 2003

Related U.S. Application Data
(60) Provisional application No. 60/372,749, filed on Apr. 15, 2002.

(51) Int. Cl. G06F 17/30

(52) U.S. Cl. 707/9

(57) ABSTRACT

An interactive electronic method for selecting and ordering subsections of a form has a user aspect that includes accessing a database housing a record containing at least one form that includes a plurality of subsections and indicia relating to the form and the subsections. At least a portion of the indicia are viewed, from which at least one of the subsections are chosen, if desired, by selecting the related indicia. When the selections are complete, the chosen subsection is ordered, and the user receives an electronic file containing an automatically assembled, unitary document incorporating the ordered subsection. The provider's aspect includes electronically offering and delivering the form subsections to the user by providing an electronic interface between a user and the database, permitting the user to choose and order a subsection, assembling the ordered subsection into a unitary document, and delivering the unitary document electronically to the user.

### CROSS-REFERENCE TO RELATED APPLICATIONS

This application is a continuation of and incorporates by reference co-pending application Ser. No. 60/372,749, filed Apr. 15, 2002, which is commonly owned with the present invention and which is incorporated herein by reference.

### BACKGROUND OF THE INVENTION

1. Field of the Invention

The present invention relates to systems and methods for customizing and ordering forms, and, more particularly, to such systems and methods for electronically creating and printing a desired form from a network.

2. Description of Related Art

Printed or electronically stored forms may comprise a plurality of individual sections. In the area of testing, such individual sections are referred to as subtests. Although tests comprising a plurality of subtests may be designed for delivery in their totality, it is also known in the art for test deliverers to elect to excise one or more subtests for delivery to a student/patient/client.

It is also known in the art to order forms such as tests electronically, such as over the Internet, and systems and methods for online ordering are also well known in the art. When ordering, however, the customer is typically forced to order and pay for full forms, even if only a part of the form is desired. This can lead to a particular problem for vendors of printed material, which is illicit photocopying of copyrighted materials, which obviously impacts profitability.

### SUMMARY OF THE INVENTION

The present invention provides a system and method for electronically providing access to subsections of a form, and for electronically selecting and ordering one or more subsections of one or more forms. Further, a system and method are provided for electronically verifying user authorization to order a selected subsection of a form, as well as for formatting and printing the selected and ordered form subsections. In addition, form subsection orders may be tracked and reported on.

These systems and methods provide a method of doing business over a network such as the Internet, and for building a user interface for electronically providing access to, selecting, and ordering one or more subsections of a form.

The present invention thus comprises an interactive system and method for electronically selecting and ordering subsections of a form. The user's aspect of the method comprises the steps of accessing a database that contains a record comprising at least one form, the form comprising a plurality of subsections. The record further comprises indicia relating to the form and the subsections thereof. At least a portion of the indicia are viewed, from which at least one of the subsections are chosen, if desired, by selecting the indicia relating thereto.

When all the selections a user desires are made, the subsection for which the indicia relating thereto was selected is ordered, and the user receives an electronic file containing an automatically assembled unitary document containing the chosen and ordered subsection.

The provider's aspect of the present invention includes a method for electronically offering and delivering the form subsections to the user. This embodiment comprises the step of providing an electronic interface between a user and a database comprising at least one form comprising a plurality of subsections, the interface having means for permitting the user to select and order at least one subsection. The method further comprises the steps of assembling the chosen and ordered subsections into a unitary document and delivering the unitary document electronically to the user.

The system of the present invention comprises the hardware and software for achieving the above-recited methods. The hardware comprises a processor at a central site and a database accessible by the processor, the database having stored therein the form and subsections thereof. Means are provided for establishing electronic communication between the processor and a network such as the Internet.

The software of the present invention, which is installable on the processor, comprises means for enabling the above-recited method steps.

A method of doing business over a network is also provided, which includes a method for electronically offering, receiving payment for, and delivering form subsections to the user. This method comprises the step of providing an electronic interface between a user and a database comprising at least one form comprising a plurality of subsections, the interface having means for permitting the user to select and order at least one subsection. The method further comprises the step of assembling the chosen and ordered subsections into a unitary document, requesting and receiving payment electronically for the unitary document, and delivering the assembled document electronically to the user.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a schematic system diagram of the present invention.

FIGS. 2A, 2B is a flow chart for the user sector of the present invention.

FIG. 3 is an exemplary screen for selecting subtests for order.

FIG. 4 is an exemplary screen for subtest selection and ordering.

FIG. 5 is an exemplary screen for finalizing and titling an order.

FIG. 6 is an exemplary screen for recalling a previously stored order.

FIG. 7 is a flow chart for the administrative sector of the present invention.

### DETAILED DESCRIPTION OF THE PREFERRED EMBODIMENTS

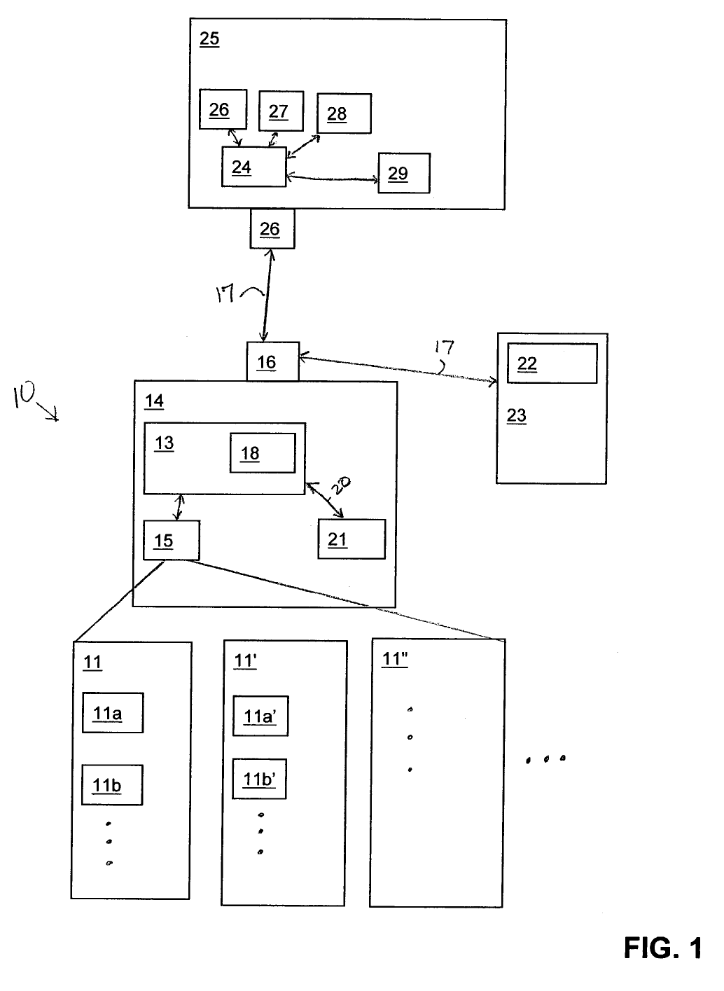

A description of the preferred embodiments of the present invention will now be presented with reference to FIGS. 1-7.

The system 10 (FIG. 1) and exemplary methods 100, 200 of the present invention are directed to providing for a selection and ordering of at least one subsection of a prepared form wherein the form subsections are intended to be coherent, self-contained, and substantially immutable. In the particular example of a test 11 comprising a plurality of subtests 11a, 11b, . . . , additional control is desired to be exercised against unauthorized access to the test 11, against tampering with the test's contents to prevent misuse, and against misapplication of full test data to any subsection(s) thereof.

The system 10 comprises a processor 13 at a central site 14 and a database 15 accessible by the processor 13. The database 15 has stored therein a plurality of tests 11, 11′, 11″, . . . , metadata associated therewith, subtests 11a, 11b, . . . , 11a′, 11b′, . . . thereof, metadata associated therewith, and registered customer information. A communication device 16 provides electronic communication between the processor 13 and a network such as the Internet 17 for providing user communications, for example. A software package 18 is resident on the processor 13 for performing the functions of the invention to be described in the following.

A link is also provided for administrative (non-user) functions, such as building and maintaining the user interface established by the software package 18 and for collecting data on user interactions. Such a link may comprise, for example, an internal electronic communications line 20 between an administrative processor 21 and the central site processor 13. Alternatively, an administrative processor 22 may also reside off-site 23, with communications then established again over the Internet 17. In either case the software package 18 would further comprise means for performing desired administrative functions such as those that will be described in the following.

A user desiring to access the system 10 will typically access the Internet 17 via a user processor 24 housed at a user site 25 remote from the central site 14 via, for example, a modem 26 or other link known in the art, including a wireless link. Exemplary peripheral devices such as a display 26, keyboard 27, pointing device 28, and printer 29 are all in electronic communication with the user processor 24, by means well known in the art.

It will be understood that alternate configurations and communications protocols are also intended to be embraced by the present invention and that no limitations are intended by the above-described hardware and software configurations.

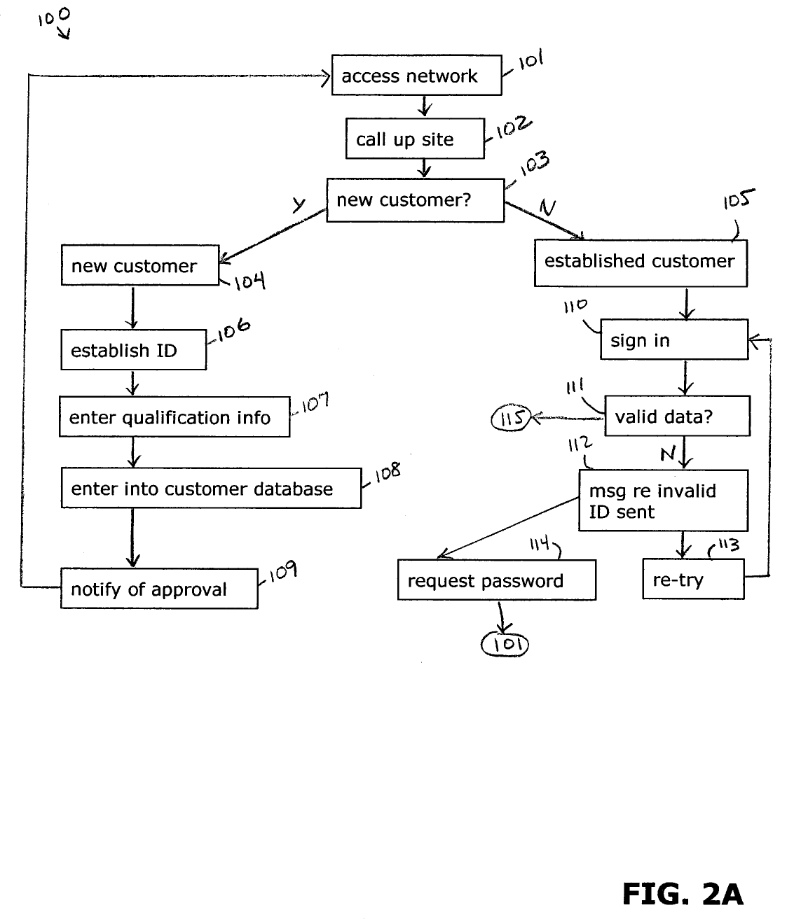

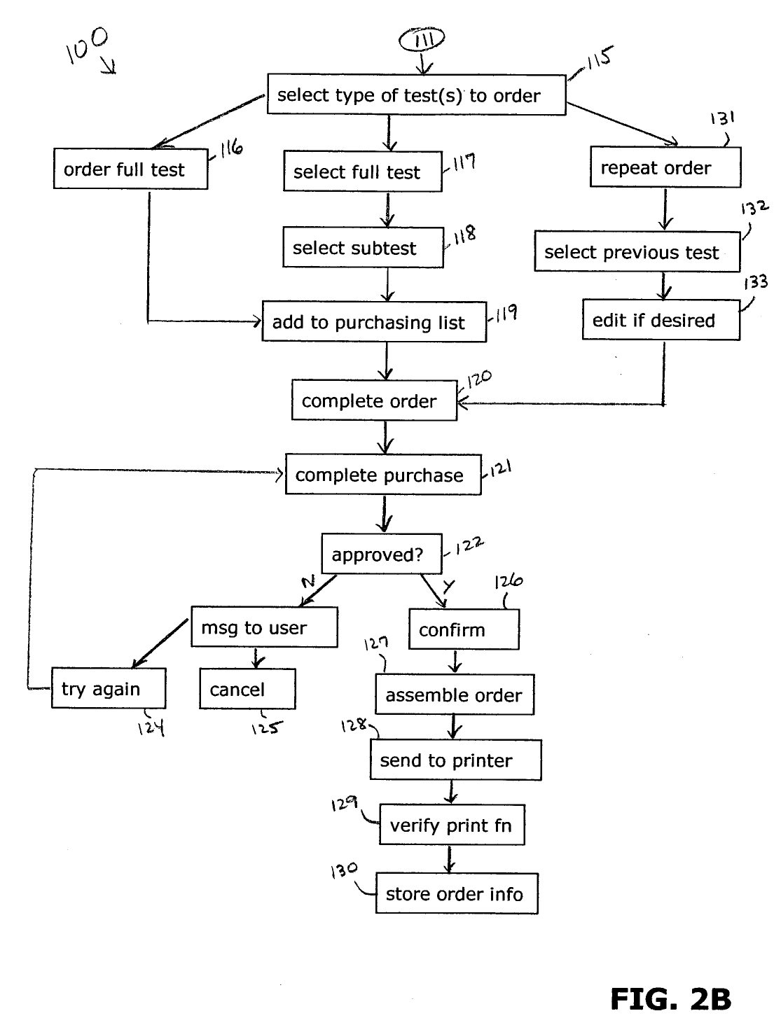

A first embodiment of a method 100 of the present invention (FIGS. 2A, 2B) is for permitting a user to electronically select and order subsections of a form, such as subtests 11a, 11b, . . . of a test 11 in this exemplary embodiment, interactively and dynamically, to form a “cross-battery” record form. The method comprises the steps of accessing a network such as the Internet (block 101) and calling up a website hosted by a purveyor of tests 11 (block 102). A choice is offered (block 103) to enter the site as a new customer (block 104) or an established customer (block 105).

If the user is a new customer, identification and registration information is requested to be established (block 106), such as a user ID and password. In addition, qualification information is requested (block 107) for the purpose of authorizing the purchase of tests 11. In a particular embodiment for ordering psychological instruments, for example, one level a three-tiered qualification would be associated with each test, requiring (A) no additional requirement, (B) a Master's level degree in psychology or education or the equivalent in a related field with relevant training in assessment, and (C) a PhD-level degree in psychology or education or the equivalent in a related field with relevant training in assessment. Further qualification information may include, but is not intended to be limited to, authorization to submit a purchase order from an organization.

Upon verification and entry into the customer sector of the database 15 (block 108), the new user is notified, such as via email (block 109), of their approval, and the new user is then able to access the system 10 (block 101) and proceed into the test-selection and order-placement phase at the appropriate level of test 11. The verification and notification steps are at present contemplated to be performed by customer service personnel; however, it will be understood by one of skill in the art that, given access to electronic records on customer qualification, these steps could in future be automated and performed completely electronically.

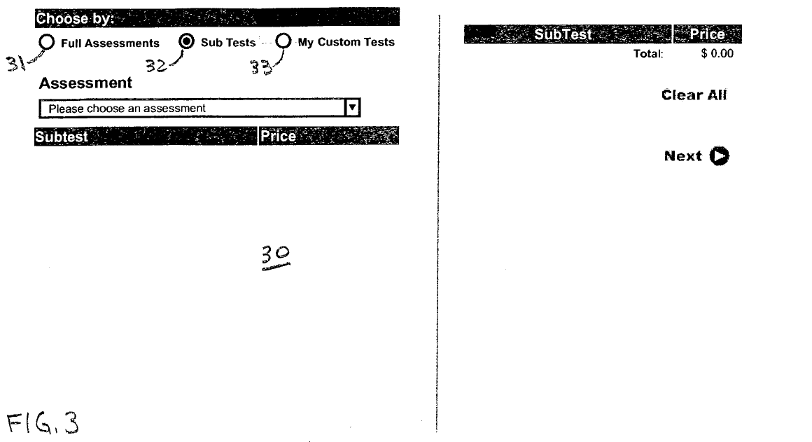

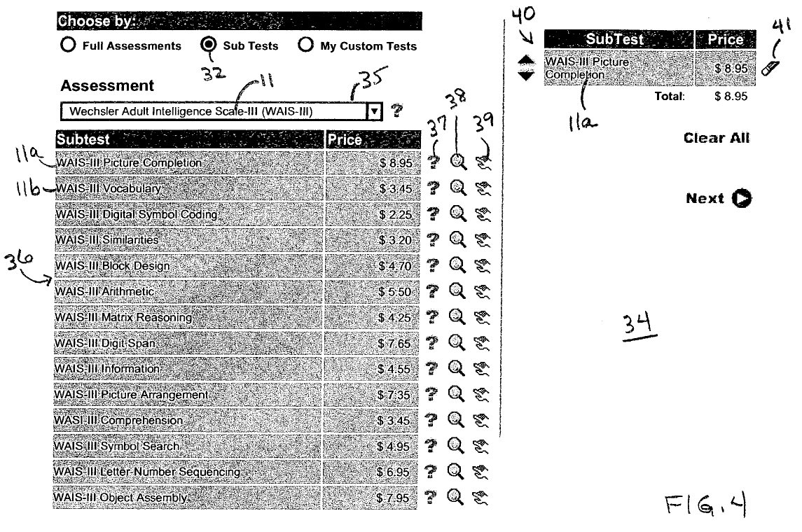

If the user is a registered customer, a sign-in process is initiated, such as by requesting an identification and password (block 110). The entered data are compared with the customer sector of the database 15 (block 111). If the data are not validated, a message is sent of an invalid ID (block 112), and the user may try again (block 113) or request their password to be sent to them (block 114) for subsequent system entry. If the entered data are valid as belonging to an authorized user, the login process is successful, a screen 30 (FIG. 3) is presented to permit the user to select (block 115) from full assessments 31, subtests 32, and previously stored customized tests 33. If the full assessment selection is made, the user may order from a list of full tests (block 116). If the subtest selection 32 is made, the user is presented with a screen 34 (FIG. 4) that has a drop-down menu 35. A selection of a full assessment 11 from the drop-down menu 35 (block 117) causes a display of a list 36 of all the subtests 11a, 11b, . . . in the selected full assessment. The user can choose to view information about a subtest by selecting the “?” 37 on the screen 34, examine the subtest by selecting the magnifying glass 38, or order the subtest by selecting the pointing hand 39 (block 118).

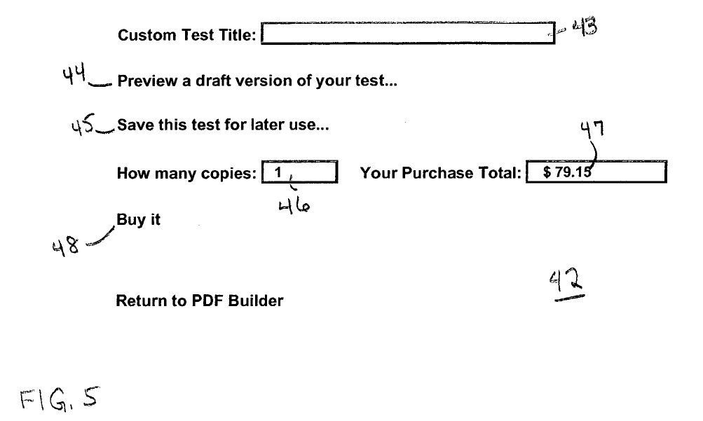

A selected subtest 11a is then added to a purchasing list 40 (block 119). An item appearing on this list 40 may also be removed therefrom by selecting the pencil eraser symbol 41 next to the list 40. The order may then be completed (block 120) by proceeding to screen 42 (FIG. 5), wherein the user may entitle 43, preview 44, save 45, and order multiple copies of 46 the customized test. The preview 44 preferably comprises a display on the user's display device 26 of the order; however, the subtest contents will not be displayed, in order to prevent unauthorized copying from the browser. The purchase total 47 appears, and the user may then complete the purchase 48, using an accepted payment method such as credit card or purchase order (block 121). If using a credit card, approval is sought (block 122); if declined, a message is sent to the user (block 123), who can try again (block 124) or cancel (block 125). If approved, a confirmatory message is sent (block 126).

If the order is approved, the order is electronically assembled (block 127) and sent to the user's printer 29 (block 128) or saved electronically on the user's system in a nonreproducible form for subsequent printout in the order selected. The print function is also verified (block 129) to ensure proper delivery to the user.

The purchased subsections are preferably assembled and delivered to the user in unitary form, as a unitary document, which has the appearance of a coherent document, rather than a collection of unrelated subtests cut and pasted together. The related information for each selected and ordered subtest 11a accompanies the subtest 11a itself, such as copyright information and administration directions. A cover and table of contents are created based upon the user's selections.

If anything less than a complete test 11 is selected and ordered, the scoring information provided to the user does not include normative data, demographic information, or scoring pages, as these elements are in the present embodiment appropriate only for a complete test 11. In this case a disclaimer is displayed to the user to indicate that the test 11 was intended to be delivered in toto, and that it cannot be scored using normative data. If a complete test 11 is selected and ordered, the entire assessment record form is printed, including demographic and summary information.

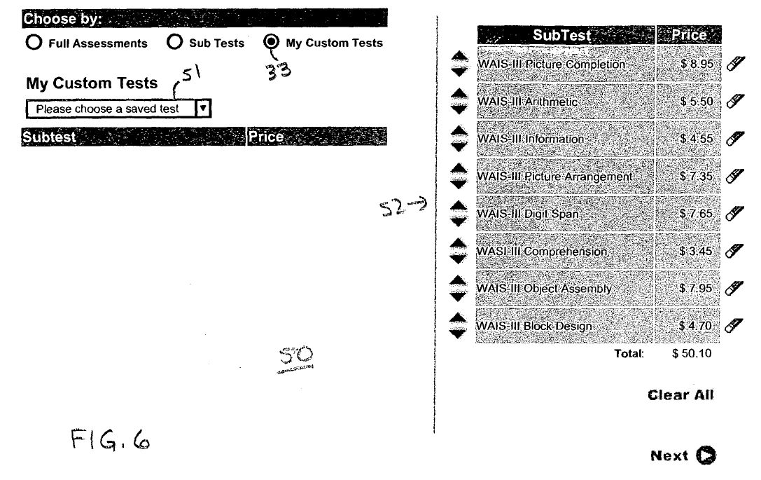

As indicated above, the system 10 also has the capability of storing user information in the customer sector of the database 15 (block 130) to minimize user reentry upon subsequent orders. In this way, a repeat order of the same subtest assembly (block 131) is made easier when accessing screen 30 (FIG. 3) and selecting the button 33 for retrieving previously stored customized tests, which displays screen 50 (FIG. 6).

A drop-down menu 51 of previously stored tests is displayed, the selection of one of which (block 132) causes a display of the components 52 thereof, which may be edited if desired (block 133). Order finalization then proceeds as above (block 120).

Links are also provided to other aspects of the purveyor's website, such as a “home”page, customer support, and an “FAQ” (frequently asked questions) page.

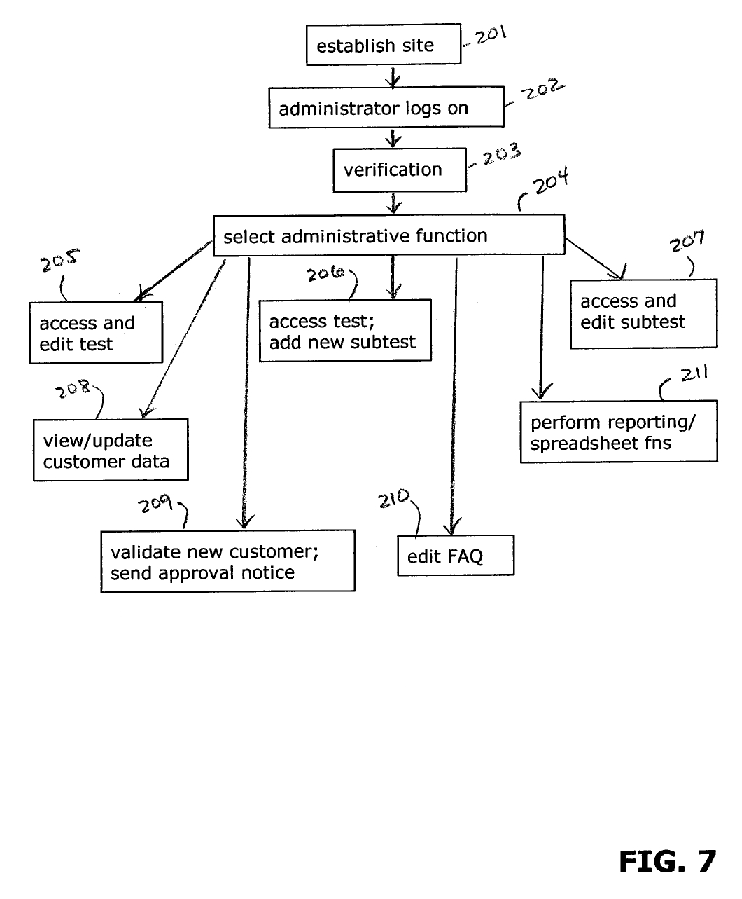

Another aspect of the present invention includes a method 200 for electronically offering and delivering a selected and ordered document to a user, and for performing attendant administrative and reporting functions on the purveyor side (FIG. 7). This method 200 comprises establishing an electronic interface, for example, a website, between a user and the database 15 comprising the at least one test 11 comprising a plurality of subtests 11a, 11b, . . . (block 201). The interface preferably comprises a series of website screens such as described above in method 100, and the method 200 thus includes performing the attendant validation, authentication, and qualification functions, which will not be repeated here.

Additional administrative steps include various maintenance and reporting functionalities carried out in communication between an administrator at administrative processor 21,22 and the central site processor 13. For example, the administrator logs on to the system 10 (block 202) and, if verified (block 203), is presented with choices (block 204) of administrative functions to perform.

If it is chosen to edit a test 11, the selected test 11 is accessed from the database 15 and presented to the administrator for the desired editing (block 205). If it is chosen to add a new subtest 11a to a test 11, the selected test 11 is accessed from the database 15 and presented to the administrator, and the administrator adds the new subtest 11a (block 206). If it is chosen to edit a subtest 11a, the selected subtest 11a is accessed from the database 15 and presented to the administrator for the desired editing (block 207). The administrator may also choose to view and/or update customer data (block 208), which entails accessing the customer sector of the database 15 and editing the appropriate data. Similarly, the administrator can validate a new customer and send approval notification (block 209). The administrator can also edit the FAQ screen (block 210) by changing an extant item, add a new item, or delete an item. Finally, the administrator can request a report, select the items for reporting, and perform other spreadsheet functions such as known in the art (block 211). As an example, a timing function can operate to track orders; for example, a sales report may be generated once a day or at some other desired interval and automatically sent to a list of administrative personnel. As is well known in the art, such sales data can be sorted by any desired criterion, such as total number of orders, orders broken down by subtest, or revenue. Another type of reporting function includes tracking copyright and royalty information, to ensure, respectively, updating of copyright information and proper payment of test authors, for example.

It may be appreciated by one skilled in the art that additional embodiments may be contemplated, including the use for selecting and ordering different types of prepared forms.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the system and method illustrated and described herein are by way of example, and the scope of the invention is not limited to the exact details disclosed herein.

Having now described the invention, the construction, the operation and use of preferred embodiment thereof, and the advantageous new and useful results obtained thereby, the new and useful constructions, and reasonable mechanical equivalents thereof obvious to those skilled in the art, are set forth in the appended claims.

What is claimed is:

1. An interactive method for electronically choosing and ordering subsections of a form comprising the steps of:
accessing a database containing a record comprising at least one form, the form comprising a plurality of subsections, and indicia relating to the form and the subsections thereof;
viewing at least a portion of the indicia;
choosing at least one of the subsections by selecting the indicia relating thereto if desired;
ordering the at least one subsection for which the indicia relating thereto was selected; and
receiving an electronic file containing an automatically assembled unitary document containing the ordered subsection.
